(19) United States
(12) Patent Application Publication
(10) Pub. No.: US 2024/0114298 A1
(43) Pub. Date: Apr. 4, 2024

(54) SYSTEM FOR OPERATING A HEARING DEVICE

(71) Applicant: SIVANTOS PTE. LTD., SINGAPORE (SG)

(72) Inventor: DIPAK CHIRMADE, ERLANGEN (DE)

(21) Appl. No.: 18/473,666

(22) Filed: Sep. 25, 2023

(30) Foreign Application Priority Data
Sep. 29, 2022 (DE) 10 2022 210 361.0

(51) Int. Cl. H04R 25/00; G06F 3/04847; G06F 3/04886; G06F 3/16

(52) U.S. Cl. CPC H04R 25/558; G06F 3/04847; G06F 3/04886; G06F 3/165

(57) ABSTRACT

The invention relates to a system (1) for operating a hearing apparatus (2). The system (1) here has a software application (4), which is installed executably on a portable device (6) and forms therewith a remote configuration device for the hearing apparatus (2). The system (1) furthermore has an electronic unit (8) adapted for short-range communication with the portable device (6). The electronic unit (8) in turn has a user input interface (10) and is adapted to send a signal (TS) to the portable device (6) in response to a user input. By means of the software application (4) or an additional software module (12), the portable device (6) is adapted to set at least one setting, which relates to a communication path of the portable device (6) to the hearing apparatus (2), to a predetermined value, and/or to carry out activation of the software application (4), in response to reception of the signal (TS).

Hearing apparatuses are conventionally used for the output of an audio signal to the auditory system of the wearer of this hearing apparatus. The output is performed here by means of an output transducer, usually acoustically through airborne sound by means of a loudspeaker (also referred to as a “pickup” or “receiver”). Often, such hearing apparatuses are used here as so-called hearing aids (also: hearing devices). For this purpose, the hearing apparatuses normally comprise an acoustic input transducer (in particular a microphone) and a signal processor, which is configured to process the input signal (also: microphone signal) generated by the input transducer from the ambient sound by using at least one signal processing algorithm, which is usually stored user-specifically, in such a way that a hearing impairment of the wearer of the hearing apparatus is compensated for at least partially. Especially in the case of a hearing aid, besides the loudspeaker the output transducer may alternatively also be a so-called bone conduction pickup or a cochlea implant which are configured for mechanical or electrical coupling of the audio signal into the auditory system of the wearer. The term “hearing apparatuses” additionally includes in particular also devices such as, for example, so-called tinnitus maskers, headsets, earphones and the like.

Typical designs of hearing apparatuses, in particular hearing devices, are behind-the-ear (“BTE”) and in-the-ear (“ITE”) hearing apparatuses. These terms refer to the intended wearing position. Thus, behind-the-ear hearing apparatuses have a (main) housing which is worn behind the pinna. Here, a distinction may be made between models whose loudspeaker is arranged in this housing—the sound output to the ear in this case usually takes place through a sound tube which is worn in the auditory canal—and models which have an external loudspeaker which is placed in the auditory canal. In-the-ear hearing apparatuses, on the other hand, have a housing which is worn in the pinna or even fully in the auditory canal.

Owing to progressive miniaturization, for reasons of space there are now only few operating elements of hearing apparatuses, in particular hearing devices, often only one or two keys for volume control and/or for turning on/off. Since hearing devices are sometimes used by people who also have to cope with further restrictions besides their hearing impairment, for example reduced sensitivity of the fingers, reduced vision or the like, hearing devices together with an associated remote control often form a hearing apparatus system in order to simplify the control of the hearing devices. By virtue of the possibilities which are now available, the remote controls are sometimes also formed by mobile devices, such as smartphones or tablets, which have control software (software application or app). Communication with the hearing apparatus takes place through wires or wirelessly, for example via a radio connection, or else often by means of acoustic signal transmission.

In the latter case, however, an output volume of the mobile device which is set too low may make it difficult to register the communication by means of the hearing apparatus, or may prevent this. For elderly people or those with little technical understanding, this may in turn lead to operating problems which in turn impair the convenience of using the hearing apparatus, at least subjectively.

The object of the invention is therefore to increase the convenience of use for hearing apparatuses.

This object is achieved according to the invention by a system for operating a hearing apparatus having the features of claim 1. This object is furthermore achieved according to the invention by the features of claim 10. Advantageous embodiments and developments of the invention, which are sometimes inventive per se, are presented in the dependent claims and the following description.

The system according to the invention is used for operating a hearing apparatus. According to a first variant of the invention, the system here has a software application (“operating app”) which is installed executably on a portable device (“mobile device”) and forms therewith a remote configuration device for the hearing apparatus. Preferably, after installation of the operating app and at least during intended use, the mobile device constitutes a part of the system. Optionally, the hearing apparatus also forms a part of the system. Furthermore, an operating element (also referred to as a “user input interface”) is provided. The mobile device is adapted (for example by means of the software application or an additional software module—for example a type of operating application for the electronic unit) to set at least one setting, which relates to a communication path of the mobile device to the hearing apparatus, to a predetermined value—and optionally also to carry out activation of the operating app—in response to a user input on the operating element.

According to a second variant of the invention, the system has a software application (“operating app”) which is installed executably on a portable device (“mobile device”) and forms therewith a remote configuration device for the hearing apparatus. Preferably, after installation of the operating app and at least during intended use, the mobile device constitutes a part of the system. Optionally, the hearing apparatus also forms a part of the system. The system furthermore has an electronic unit adapted for short-range communication with the portable device. The electronic unit has a user input interface and is adapted to send a signal (“trigger signal”) to the mobile device in response to a user input (particularly into the user input interface). By means of the software application or an additional software module (for example a type of operating application for the electronic unit), the mobile device is adapted to set at least one setting, which relates to a communication path of the mobile device to the hearing apparatus, to a predetermined value, and/or to carry out activation of the operating app, in response to reception of the trigger signal.

The mobile device is preferably a smartphone, a tablet, a mixture thereof, optionally also a laptop, or the like.

Preferably, the value for the setting is predetermined in such a way that-preferably direct, i.e. immediate—communication between the mobile device and the hearing apparatus is actually made possible.

The invention in this case has the advantage that by means of a user input (preferably only one user input) the operating app is started and/or at least one setting for the communication between the mobile device and the hearing apparatus is performed. Although smartphones and/or tablets in particular are often adapted to output warning messages during the operation of a software application, when correspondingly required settings and/or permissions are not suitable or are absent (for example when data protection permissions are missing, wireless interfaces are inactive, or the like), a dialog by means of which the user can “redo” (for example i.e. activate) the settings often being offered, especially for elderly users or those with little experience, technical understanding or other physical restrictions (reduced (finger) motor control, reduced vision or the like) such dialogs however also represent an at least certain barrier which restricts the subjective user convenience.

Preferably, the mobile device is adapted to set the setting at the predetermined value or start (activate) the operating app in response to the reception of the trigger signal described above, or in response to the user input on the operating element, without further query or confirmation. This is advantageous insofar as the user no longer needs to provide additional confirmation of the initiated action, which would in turn be a hindrance for the aforementioned restricted users during operation.

Preferably, for this purpose the electronic unit is linked by signal transmission technology to the mobile device, for example via a kind of “handshake”, and/or is installed, stored or the like by means of an app (for example the aforementioned additional software module) on the mobile device. In this way, the electronic unit is in particular known to the mobile device, so that the latter can employ the trigger signal as an “authorized” setting instruction even without query. Furthermore optionally, however, the short-range communication between the electronic unit and the mobile device may already be used as sufficient authorization since such short-range communication, which preferably functions merely only over a few centimeters, for example up to at most 30 centimeters, may be assumed to be relatively secure against unauthorized access.

According to one preferred embodiment—in particular the first variant of the invention—the operating element is formed by a button (also: “virtual” switch or key) produced (implemented) in software technology, which is preferably represented on a touch-sensitive screen (display) of the mobile device. In particular, it is thus a kind of widget or control field which is displayed on the (touch) display. Optionally, it may be a widget that is enlarged in relation to other widgets or control fields, which is preferably also displayed on a homepage of the mobile device. In this way, the operating element is clearly visible and also simple to operate. This is helpful for persons with motor and/or visual restrictions since they do not first need to navigate through a menu structure—which is often subjectively complex for many inexperienced users. For example, the widget or the control field may be a “start button” for the corresponding operating app, so that with the user input on the operating element (that is to say touching or “clicking” on the widget) the operating app is started and the communication connection is advantageously also set to the predetermined path, in particular activated or set up.

Particularly preferably, the electronic unit adapted for the short-range communication with the portable device is an NFC tag or an NFC accessory. NFC—an abbreviation for “near-field communication”—is adapted and provided as a transmission standard, in particular for—preferably inductive—signal transmission according to the principle of RFID technology, already per se for transmission with ranges in the region of a few 10 s of centimeters, in particular even less than 10 centimeters. Such short transmission ranges, as described above, allow control of the mobile device even without additional (user) permission.

In one expedient embodiment, the communication path of the portable device is a loudspeaker, a wireless interface and/or a screen—for in particular direct communication, that is to say without an intermediate “relay” or the like.

In one development of the system, the electronic unit, in particular the NFC tag or the NFC accessory, is adapted to send a specified setting instruction to the portable device in the scope of the trigger signal. In other words, in this development the signal contains for example a concrete instruction which the mobile device should or can carry out. Alternatively, the mobile device is adapted to react to the trigger signal containing only an instruction (in particular a nonspecific instruction) quasi-autonomously (i.e. in particular on the basis of “workflows” of the operating app or of the additional software module) with a corresponding measure.

Expediently, the mobile device is adapted to set an audio output volume (or else: loudspeaker volume) to a predetermined minimum value, preferably to at least 50%, in response to reception of the trigger signal or in response to the user input on the operating element. This is expedient in particular for use with an acoustically remote-controllable hearing apparatus. In this case, the user no longer necessarily needs to adapt the audio output volume per se in order to obtain a satisfactory result, in particular acoustic registering of the acoustic control signal by the hearing apparatus.

In an alternative or additional embodiment, the mobile device is adapted to activate the specific wireless interface in response to reception of the trigger signal or in response to the user input on the operating element. In particular, the wireless interface is an interface that operates according to the Bluetooth standard (“Bluetooth interface”). Alternatively, the mobile device may however also be adapted for short-range (or else: near-field) communication (NFC) with the hearing apparatus. In this case the NFC interface, in particular an NFC transmitter, of the mobile device is optionally activated.

In a further expedient embodiment, the mobile device is (preferably additionally) adapted to end a quiet or do not disturb operating mode, optionally also a “flight mode”, in response to reception of the trigger signal or in response to the user input on the operating element. Cell phones or tablets in particular have the option of adopting a quiet mode, in the scope of which for example the loudspeaker is set to silent and/or further communication interfaces (for example wireless interfaces) are deactivated. This is expedient in particular for the case in which the loudspeaker volume can optionally be increased even during the quiet mode, but remains without any actual effect because of prioritization of the quiet mode since the loudspeaker is deactivated overall, and in this case, such a volume change might not take effect until the quiet mode is deactivated.

Additionally or alternatively, the mobile device is expediently adapted to check whether a sound profile is set to silent (also referred to as “mute”) in response to reception of the trigger signal or in response to the user input on the operating element, and in this case to set the sound profile to normal.

Optionally, the mobile device is furthermore adapted to carry out the measures described above—that is to say in particular the setting of the audio output volume at the minimum value, the activation of the wireless interface, the ending of the quiet or do not disturb operating mode and/or the ending of the “mute” sound profile—only for the use of the operating app described above. For other applications, provision may therefore optionally be made to leave the aforementioned settings unchanged (for a phone call or messenger app, for example, the do not disturb operating mode thus continues).

Particularly in order to avoid a communication connection between the mobile device and the hearing apparatus being interrupted and not resumed-sometimes the coupling of the two devices is displayed but no data transmission takes place-, the mobile device in a further expedient embodiment (additionally or alternatively to the embodiments described above) is adapted to disconnect and reconnect a communication connection to the hearing apparatus in response to reception of the signal. In this way, in particular, recoupling to the hearing apparatus is “forced”.

In a further expedient embodiment, particularly for the case in which the mobile device is not adapted for communication with the electronic unit on the basis of the operating app, the mobile device is adapted, in particular by means of the additional software module, to search through applications installed on the mobile device itself for an instruction set for the remote setting of a hearing apparatus in response to reception of the trigger signal, and if no such instruction set is found, to output an indication to a user of the device. In other words, the mobile device is in particular adapted to check in response to reception of the trigger signal whether the operating app (or a similar software application) is installed.

Furthermore, the mobile device is expediently adapted to set a function for adapting a screen brightness to adaptive, in particular also to automatic operation, in response to reception of the trigger signal.

Here and in what follows, the conjunction “and/or” is intended in particular to be understood as meaning that the features associated by means of this conjunction may be configured both together and as alternatives to one another.

Exemplary embodiments of the invention will be explained in more detail below with the aid of a drawing, in which:

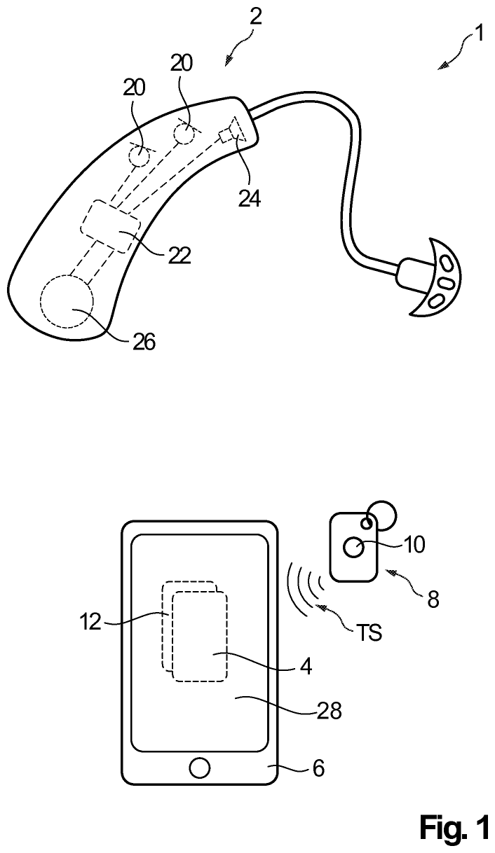

FIG. 1 shows a schematic view of a system for operating a hearing apparatus,

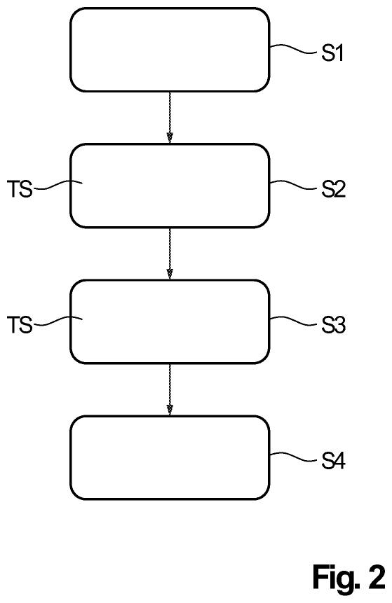

FIG. 2 shows a schematic flowchart of a method sequence of the system during intended operation, and

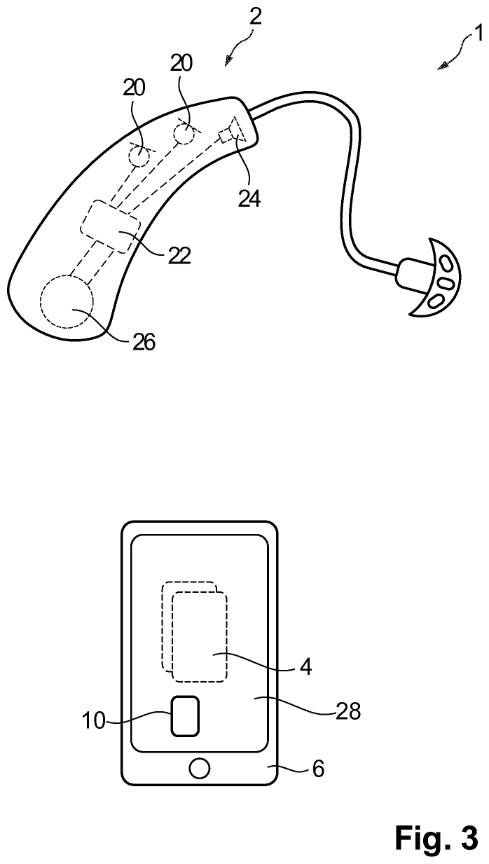

FIG. 3 shows a schematic view of a further exemplary embodiment of the invention.

Parts which correspond to one another are always provided with the same reference signs in all the figures.

FIG. 1 represents a system 1 for operating a hearing apparatus 2. The system 1 has a software application (“operating app 4”), which is executably installed on a portable device (also: mobile device, here “smartphone 6”). The smartphone 6 therefore becomes part of the system 1 during intended use, and together with the operating app 4 forms a remote configuration device for the hearing apparatus 2. The system 1 furthermore has an electronic unit adapted for short-range communication with the smartphone 6. The electronic unit is in this case formed by an NFC tag 8. This NFC tag 8 in turn has a user input interface, which is formed by a button 10. The NFC tag 8 is in this case adapted to send a signal (“trigger signal TS”) to the smartphone 6 (coupled to or optionally paired with the NFC tag 8) in response to a user input (that is to say in response to actuation of the button 10). The smartphone 6 is adapted by means of the operating app 4, or alternatively by means of an additional software module (specifically a further app, here: “NFC app 12”) to engage at least one measure, which relates to the communication between the smartphone 6 and the hearing apparatus 2, in response to the trigger signal TS.

For the case in which the smartphone 6 is adapted by means of the NFC app 12 to interpret the trigger signal TS as an initiator of a subsequent measure; in an alternative variant, the smartphone 6 is also adapted to carry out activation of the operating app 4.

In the present exemplary embodiment, the hearing apparatus 2 is a hearing aid. In the present exemplary embodiment, the latter is formed by a so-called behind-the-ear (for short: “BTE”) hearing aid and comprises here two microphones 20, a signal processor 22 coupled thereto, and a loudspeaker 24 which is in turn coupled on the output side to the signal processor 22. The hearing aid 2 furthermore has an energy storage unit 26 for the energy supply of the aforementioned components. Without restriction, the hearing aid may however also be configured by another hearing aid design, for example as an in-the-ear hearing aid (for short: “ITE”).

The signal processor 22 is adapted to process signals received from the microphones 20, depending on the hearing impairment of the user of the hearing aid for example to frequency-dependently amplify them, to filter them, and the like. The signal processor 22 outputs a processed signal, which may additionally be amplified or attenuated overall (in the sense of a volume adjustment), to the loudspeaker 24.

The user often has the opportunity, besides the volume, also to select various hearing programs—adjustment sets which are adapted for specific hearing situations, for example for talking in a quiet background, talking with interfering noise, television and the like—in order to adapt the signal processing actively to a modified hearing situation. Since hearing aids are becoming smaller and smaller, physical interfaces on the hearing aid itself are also becoming rarer. To carry out adjustments, hearing aids therefore often have a remote control. Owing to the capability of smartphones and the like to communicate with many third-party devices, for example via radio or the like, it is feasible to use smartphones as a remote control for hearing aids.

One disadvantage, particularly for people who have physical, in particular motor and/or visual, restrictions, is however that required adjustments on the smartphone 6 in the event of problems with data transmission from the smartphone 6 to the hearing apparatus 2 often cannot readily be understood or can scarcely be carried out by such users.

The system 1 therefore also comprises the NFC tag 8. The system 1 is adapted to carry out an operating method in interaction with the user. Exemplary steps of the method are schematically represented in FIG. 2. The method is based here on the NFC tag 8 being coupled to the smartphone 6 or at least known to the latter (that is to say, a coupling, a “handshake” or the like has already been carried out). In an alternative exemplary embodiment, such a coupling and/or a “handshake” may also be obviated. In such a case, the authentication (and in particular a kind of authentication) of the NFC tag 8 is carried out only on the basis of its required proximity to the smartphone 6 in order actually to be able to exchange signals with the latter. Here, the assumption is thus made that it is sufficiently certain on the basis of the required proximity of the NFC tag 8 to the smartphone 6, for example less than 10 centimeters, that the user is operating the NFC tag 8.

In the scope of the method, it is furthermore assumed that the user wishes to carry out adjustments on the smartphone 6, for example a change in a current hearing program. The adjustments themselves may be carried out by the user in the operating app 4. In order to prepare the smartphone 6 for the imminent communication with the hearing apparatus 2, in a first step S1 the user takes the NFC tag 8 and brings it into the immediate vicinity (that is to say at a distance equal to or less than 10 centimeters) of the smartphone 6. In a second step S2, the user then actuates the button 10 of the NFC tag 8. The latter thereupon sends the trigger signal TS, which is received by the smartphone 6 in a third step S3, by means of short-range communication.

By the received trigger signal TS, the smartphone 6 is prompted in a fourth step S4 to engage the at least one measure which relates to the communication between the smartphone 6 and the hearing apparatus 2. For example, the smartphone 6 in this case sets at least one setting, which relates to a communication path of the smartphone 6 to the hearing apparatus 2, to a predetermined value.

In a first exemplary embodiment, the smartphone 6 specifically sets a loudspeaker volume to at least 50 percent or more as the measure. This is advantageous insofar as many hearing apparatuses 2 can be driven acoustically. In concrete terms, a setting instruction is transmitted from the smartphone 6 to the hearing apparatus 2 acoustically, normally with an audio level that is inaudible or scarcely audible for persons with normal hearing. So that this setting instruction can be received by the hearing apparatus 2, specifically by the microphones 20 thereof, a usually sufficiently high output volume is in this case quasi-automatically preset. With the assumption that, for intended use, the smartphone 6 is in the user's hand and the hearing apparatus is on their ear, a volume setting of at least 50 percent is regarded as sufficient. Should the existing volume setting of the smartphone 6 already be set higher, resetting of the volume setting advantageously does not take place. Subsequently, the user may select a setting for the hearing apparatus 2 in the operating app 4 and subsequently output this to the hearing apparatus 2 with a corresponding volume.

In an alternative exemplary embodiment, as the measure, the smartphone 6 activates a wireless interface, which for example operates according to the Bluetooth standard, in order to set up a wireless communication connection with the hearing apparatus 2. This is expedient for cases in which the remote controlling of the hearing apparatus takes place on the basis of radio rather than acoustically.

In a further exemplary embodiment (additionally or alternatively to the exemplary embodiments mentioned above), as the measure, the smartphone 6 deactivates a currently activated quiet, flight or do not disturb mode (or similar modes in which, in particular, data transmission interfaces and/or loudspeakers are deactivated or set to be particularly quiet) and activates a normal operating mode of the smartphone 6.

In both cases, instructions corresponding to the respective measures are contained in the operating app 4 or the additional software module, that is to say stored in a “workflow” which is started on reception of the trigger signal TS. Alternatively, however, the NFC tag 8 may also be adapted to deliver an instruction aimed at the respective measure (or even at a plurality of measures) in the scope of the trigger signal TS. This instruction then prompts the smartphone 6 directly to engage the measures described above.

FIG. 3 schematically represents a further exemplary embodiment of the invention. The system 1 differs from the exemplary embodiment described above merely in that the NFC tag 8 is absent. The button 10 is in this case depicted by software technology on the smartphone 6. Specifically, during its installation on the smartphone 6, the operating app 4 stores a widget, that is to say a control field (also: “button”), which forms an operating element in the form of the button 10 and is displayed on a touch-sensitive screen 28 (“display”) of the smartphone 6. The smartphone 6 is furthermore adapted for direct, wireless communication with the hearing apparatus 2. In response to the registration of a user input on the button 10, the smartphone 6 carries out the measures described above in a similar way as for the reception of the trigger signal TS.

The invention described above has the advantage that almost automatic “preparation” of the smartphone 6 for a subsequent data transmission to the hearing apparatus 2 takes place. The respective measure of this preparation is in this case preferably carried out only for the case in which there are currently no necessary adjustments. Preferably, the smartphone 6 thus checks whether, for example, a current volume setting already lies above 50 percent and, if this is the case, does not carry out the measure. For users, this particularly effectively avoids error messages, possibly with proposed solutions, which are at least burdensome or—depending on knowledge about the smartphone 6 or on physical requirements—difficult to manage, being generated in the operating app 4 when starting the operating app 4, or even only when sending the corresponding adjustment instruction. The subject matter of the invention is not restricted to the exemplary embodiments described above. Rather, further embodiments of the invention may be derived by a person skilled in the art from the description above. In particular, the individual features of the invention which have been described with the aid of the various exemplary embodiments, and the configuration variants thereof, may also be combined with one another in a different way.

### LIST OF REFERENCE SIGNS

1 system
2 hearing apparatus
4 operating app
6 smartphone
8 NFC tag
10 button
12 NFC app
20 microphone
22 signal processor
24 loudspeaker
26 energy storage unit
28 screen
TS trigger signal
S1-S4 step

1. A system (1) for operating a hearing apparatus (2), having
a software application (4), which is installed executably on a portable device (6) and forms therewith a remote configuration device for the hearing apparatus (2),
wherein an operating element (10) is provided, and wherein the portable device (6) is adapted to set at least one setting, which relates to a communication path of the portable device (6) to the hearing apparatus (2), to a predetermined value in response to a user input on the operating element (10).

2. The system as claimed in claim 1,
wherein the operating element (10) is formed by a button produced in software technology, in particular on a touch-sensitive screen (28), of the portable device (6).

3. The system as claimed in claim 1,
wherein the communication path of the portable device (6) is a loudspeaker (24), a wireless interface and/or a screen for direct communication with the hearing apparatus (2).

4. The system as claimed in claim 3,
wherein the portable device (6) is adapted to activate the wireless interface, which is preferably formed by a Bluetooth interface, in response to the user input on the operating element (10).

5. The system as claimed in claim 1,
wherein the portable device (6) is adapted to set an audio output volume to a predetermined minimum value, preferably to at least 50%, in response to the user input on the operating element (10).

6. The system as claimed in claim 1,
wherein the portable device (6) is adapted to end a quiet or do not disturb operating mode in response to the user input on the operating element (10).

7. The system as claimed in claim 1,
wherein the portable device (6) is adapted to check whether a sound profile is set to silent in response to the user input on the operating element (10), and in this case to set the sound profile to normal.

8. The system as claimed in claim 1,
wherein the portable device (6) is adapted to disconnect and reconnect a communication connection to the hearing apparatus (2) in response to the user input on the operating element (10).

9. The system as claimed in claim 1,
wherein the portable device (6) is adapted to set a function for adapting a screen brightness to adaptive, in particular also to automatic operation, in response to the user input on the operating element (10).

10. A system (1) for operating a hearing apparatus (2), having
a software application (4), which is installed executably on a portable device (6) and forms therewith a remote configuration device for the hearing apparatus (2),
an electronic unit (8) adapted for short-range communication with the portable device (6),
wherein the electronic unit (8) has a user input interface (10) and is adapted to send a signal (TS) to the portable device (6) in response to a user input,
wherein by means of the software application (4) or an additional software module (12), the portable device (6) is adapted to set at least one setting, which relates to a communication path of the portable device (6) to the hearing apparatus (2), to a predetermined value, and/or to carry out activation of the software application (4), in response to reception of the signal (TS).

11. The system as claimed in claim 10,
wherein the electronic unit adapted for short-range communication with the portable device (6) is an NFC tag (8) or an NFC accessory.

12. The system as claimed in claim 10,
wherein the communication path of the portable device (6) is a loudspeaker (24), a wireless interface and/or a screen.

13. The system as claimed in claim 10,
wherein the electronic unit (8) is adapted to send a specified setting instruction to the portable device (6) in the scope of the signal (TS).

14. The system as claimed in claim 10,
wherein the portable device (6) is adapted to set an audio output volume to a predetermined minimum value, preferably to at least 50%, in response to reception of the signal (TS).

15. The system as claimed in claim 10,
wherein the portable device (6) is adapted to activate the wireless interface, which is preferably formed by a Bluetooth interface, in response to reception of the signal (TS).

16. The system as claimed in claim 10,
wherein the portable device (6) is adapted to end a quiet or do not disturb operating mode in response to reception of the signal (TS).

17. The system as claimed in claim 10,
wherein the portable device (6) is adapted to check whether a sound profile is set to silent in response to reception of the signal (TS), and in this case to set the sound profile to normal.

18. The system as claimed in claim 10,
wherein the portable device (6) is adapted to disconnect and reconnect a communication connection to the hearing apparatus (2) in response to reception of the signal (TS).

19. The system as claimed in claim 10,
wherein the portable device (6) is adapted to search through applications installed on the device (6) itself for an instruction set for the remote setting of a hearing apparatus (2) in response to reception of the signal (TS), and if no such instruction set is found, to output an indication to a user of the device (6).

20. The system as claimed in claim 10,
wherein the portable device (6) is adapted to set a function for adapting a screen brightness to adaptive, in particular also to automatic operation, in response to reception of the signal (TS).
